(19) United States
(12) Patent Application Publication
(10) Pub. No.: US 2025/0368390 A1
(43) Pub. Date: Dec. 4, 2025

(54) PACKAGING METHOD FOR SPRING MATTRESS AND PACKAGING DEVICE FOR SPRING MATTRESS

(71) Applicant: Luhao LENG, Xiamen (CN)

(72) Inventor: Luhao LENG, Xiamen (CN)

(21) Appl. No.: 19/223,653

(22) Filed: May 30, 2025

(30) Foreign Application Priority Data
May 30, 2024 (CN) 202410693226.8

(51) Int. Cl. B65D 21/02; A47C 27/04; B62B 3/04; B62B 3/10; B62B 5/06; B65D 85/64

(52) U.S. Cl. CPC B65D 21/023; B62B 3/04; B62B 3/10; B62B 5/06; B65D 85/64; A47C 27/04; B62B 2203/00; B62B 2301/00; B65D 2585/647

(57) ABSTRACT

A spring mattress includes an upper cushion layer, an elastic module, and a bottom plate, where the elastic module is formed by detachably connecting a plurality of spring units, and the bottom plate is formed by detachably splicing or unfolding a plurality of bottom plate units. A packaging method for the spring mattress includes packaging the plurality of spring units using at least two of a plurality of packaging containers, packaging the upper cushion layer using a single one of the plurality of packaging containers, and packaging the plurality of bottom plate units using two or fewer of the plurality of packaging containers.

### RELATED APPLICATIONS

This application claims priority to Chinese patent application number 202410693226.8, filed on May 30, 2024. Chinese patent application number 202410693226.8 is incorporated herein by reference.

### FIELD OF THE DISCLOSURE

The present disclosure relates to the field of furniture transportation, specifically relating to a packaging method for a spring mattress and a packaging device for the spring mattress.

### BACKGROUND OF THE DISCLOSURE

Most existing spring mattresses are constructed as a single, integrated unit, which results in a large overall size and higher costs for transportation or storage. To enhance the comfort of mattresses, designs featuring detachable elastic modules have been developed. This allows for the adjustment of springs in different areas of the mattress as needed, enabling varying levels of firmness across different sections of the same mattress. Additionally, the springs can be disassembled for separate transportation.

While disassembling spring mattresses for transport significantly improves convenience, certain challenges remain in their handling and movement. Even with categorized packaging and transportation methods, issues such as time-consuming assembly, difficulty in disassembly, and cumbersome movement persist, ultimately affecting their usability.

### BRIEF SUMMARY OF THE DISCLOSURE

The present disclosure provides a packaging method for a spring mattress and a packaging device for the spring mattress, which can reduce an individual packaging size of the spring mattress, facilitate transportation and handling, save labor costs, and prevent damage or deformation of the spring mattress.

In order to solve the above technical problems, the present disclosure provides a packaging method for a spring mattress. The spring mattress comprises an upper cushion layer, an elastic module, and a bottom plate. The elastic module is formed by detachably connecting a plurality of spring units, and the bottom plate is formed by detachably splicing or unfolding a plurality of bottom plate units. The packaging method comprises packaging the plurality of spring units using at least two of a plurality of packaging containers, packaging the upper cushion layer using a single one of the plurality of packaging containers, and packaging the plurality of bottom plate units using two or fewer of the plurality of packaging containers.

In some embodiment, the plurality of spring units are configured to be locked in a compressed state, and the plurality of spring units locked in the compressed state are stacked in the at least two of the plurality of packaging containers.

In some embodiment, the plurality of spring units are configured to be stacked in the at least two of the plurality of packaging containers in a form of N₁×N₂×N₃, wherein N₁ is greater than or equal to 1, N₂ is greater than or equal to 1, and N₃ is greater than or equal to 1.

The present disclosure provides a packaging device for a spring mattress. The spring mattress comprises an upper cushion layer, an elastic module, and a bottom plate. The elastic module is formed by detachably connecting a plurality of spring units, and the bottom plate is formed by detachably splicing or unfolding a plurality of bottom plate units. The plurality of spring units are configured to be packaged using at least two of a plurality of packaging containers, and the upper cushion layer is configured to be packaged using a single one of the plurality of packaging containers. The plurality of bottom plate units are configured to be packaged using two or fewer of the plurality of packaging containers.

In some embodiment, the upper cushion layer is rolled up or folded to be put into the single one of the plurality of packaging containers.

In some embodiment, the bottom plate is configured to be stacked in the two or fewer of the plurality of packaging containers after being disassembled from the plurality of spring units.

In some embodiment, each of the plurality of packaging containers comprises a lifting handle.

In some embodiment, a surface of one of the plurality of packaging containers is disposed with an insertion member, and a surface of another one of the plurality of packaging containers opposite to the surface of the one of the plurality of packaging containers is disposed with an insertion matching member. When the plurality of packaging containers are stacked along a vertical direction, the insertion member and the insertion matching member are matched with each other by insertion.

In some embodiment, a surface of each of the plurality of packaging containers comprises a circular hole, and the circular hole on a lower surface of the one of the plurality of packaging containers is mounted with a protruding platform as the insertion member. The circular hole on an upper surface of the another one of the plurality of packaging containers is mounted with a recessed platform as the insertion matching member.

In some embodiment, a surface of each of the plurality of packaging containers comprises a circular hole, and the circular hole on an upper surface of the one of the plurality of packaging containers is mounted with a protrusion protruding in a vertical upward direction as the insertion member. The circular hole on a lower surface of the another one of the plurality of packaging containers is mounted with a recess recessed in the vertical upward direction as the insertion matching member.

In some embodiment, an upper side of the protrusion comprises a protruding edge extending radially outward, and a width of the protruding edge gradually narrows along an insertion direction to form an inclined surface. The recess comprises an opening into which the protruding edge is inserted.

The present disclosure provides a transport cart for a detachable spring mattress. The transport cart is configured to transport the detachable spring mattress, and the transport cart comprises a cart, and the packaging device is stacked on the cart. The cart comprises a fixing member, and the fixing member is configured to fixing the packaging device on the cart.

In some embodiment, the cart comprises a load-bearing portion configured to support the packaging device, and rollers are disposed below the load-bearing portion.

In some embodiment, the fixing member is one or more straps.

In some embodiment, a handle is disposed above the load-bearing portion, and the handle is configured to be pushed to drive the cart.

In some embodiment, the handle has rotational freedom relative to the load-bearing portion, and the handle is configured to be rotated to be parallel to the load-bearing portion.

In some embodiment, the load-bearing portion is a bottom supporting plate in a plate shape, and a surface of the bottom supporting plate comprises a groove having a shape matched with a shape of the handle for receiving the handle when the handle is rotated to be parallel to the load-bearing portion.

In some embodiment, the fixing member is a guardrail provided around the load-bearing portion to fix the packaging device on the cart.

In some embodiment, the guardrail comprises a first rail parallel to the load-bearing portion and one or more second rails connected to the first rail and the load-bearing portion.

In some embodiment, the first rail is divided into two fixed rods and two movable rods, and the two fixed rods are arranged opposite to each other. The two movable rods are respectively rotatably connected between ends of the two fixed rods.

In some embodiment, each of the two movable rods is divided into two sub-movable rods, and ends of the two sub-movable rods facing away from each other are respectively rotatably connected to the ends of the two fixed rods. Ends of the two sub-movable rods facing each other are rotatably connected.

In some embodiment, the one or more second rails are a plurality of second rails, and two ends of each of the plurality of second rails are respectively connected to the first rail and the load-bearing portion. Middle sections of adjacent second rails of the plurality of second rails on a same side of the load-bearing portion extend toward each other and are connected together.

In some embodiment, each of the plurality of second rails comprises an upper rail, a lower rail, and a connecting member. A first end of the upper rail is connected to the first rail, and a first end of the lower rail is connected to the load-bearing portion. A second end of the upper rail and a second end of the lower rail are connected to the connecting member, and the connecting members of two adjacent second rails of the plurality of second rails are pivotally connected.

In some embodiment, the load-bearing portion comprises two first transverse rods, two second transverse rods, and one or more connecting rods. The two first transverse rods and the two second transverse rods are connected to form a rectangular frame, and the one or more connecting rods are connected between the two first transverse rods for carrying the packaging device.

In some embodiment, each of the two first transverse rods comprises a first part and a second part, and the first part and the second part are respectively rotatably connected to the two second transverse rods. The first part and the second part are pivotally connected together to form a corresponding one of the two first transverse rods.

In some embodiment, two ends of each of the two fixed rods extend vertically downward to form a space for the rollers to be inserted, and two ends of the two movable rods are respectively connected to the two ends of a corresponding one of the two fixed rods which extend downward.

Compared with the existing techniques, the technical solution has the following advantages.

The packaging method and the packaging device provided by the present disclosure reduces a packaging space by packaging the upper cushion layer, the plurality of spring units constituting the elastic module, and the plurality of bottom plate unit constituting the bottom plate in the plurality of packaging containers and stacking the plurality of packaging containers for transportation, thereby saving space and manpower for manual handling and transportation, and preventing the parts of the spring mattress from being damaged and deformed due to improper stacking.

The transport cart provided by the present disclosure is achieved by stacking the first packaging container, the at least two second packaging containers, and the two or fewer third packaging containers on the cart and fixing the first packaging container, the at least two second packaging containers, and the two or fewer third packaging containers with the fixing member. Therefore, merchants can conveniently transport the spring mattress when shipping or users can stack the first packaging container, the at least two second packaging containers, and the two or fewer third packaging containers firmly when moving, thereby saving labor costs.

### BRIEF DESCRIPTION OF THE DRAWINGS

FIG. 1 is a perspective view of a transport cart in Embodiment 1.

FIG. 2 is a perspective view of an upper cushion layer and an elastic module of a spring mattress.

FIG. 3 is a perspective view of the upper cushion layer.

FIG. 4a is a perspective view of the upper cushion layer packaged in a first packaging container, which is flat.

FIG. 4b is a perspective view of the upper cushion layer packaged in the first packaging container, which is elongated.

FIG. 5 is a perspective view of a spring unit, when the spring unit is compressed.

FIG. 6 is a perspective view of the spring units stacked in a 1*1*10 array.

FIG. 7 is a perspective view of the spring units shown in FIG. 6 and packaged in a second packaging container.

FIG. 8 is a perspective view of a spring unit module.

FIG. 9 is a perspective view of the spring unit module shown in FIG. 8 in a compressed state.

FIG. 10 is a perspective view of the spring unit module shown in FIG. 9 and packaged in the second packaging container.

FIG. 11 is a perspective view of the spring units stacked in a 2*5 array in the second packaging container.

FIG. 12 is a perspective view of the spring units stacked in a 4*5 array in the second packaging container.

FIG. 13 is a perspective view of the spring units stacked in the second packaging container in a 2*5*5 array.

FIG. 14 is a perspective view of stacking the second packaging containers and third packaging containers.

FIG. 15 is a perspective view of a bottom plate.

FIG. 16 is a perspective view of the bottom plate and the spring units stacked in packaging containers.

FIG. 17 is a perspective view of each of the packaging containers.

FIG. 18 is a perspective view of a packaging device according to Embodiment 1.

FIG. 19 is a perspective view of a cart according to Embodiment 1.

FIG. 20 is a perspective view of a packaging device in Embodiment 2.

FIG. 21 is a front view of a transport cart of Embodiment 2.

FIG. 22 is a side view of the transport cart according to Embodiment 2.

FIG. 23 is a front view of a cart of Embodiment 2.

FIG. 24 is a side view of the cart of Embodiment 2.

FIG. 25 is a top view of the cart of Embodiment 2.

FIG. 26 is a perspective view of a transport cart in Embodiment 3.

FIG. 27 is a side view of a transport cart according to Embodiment 3.

FIG. 28 is a front view of the transport cart of Embodiment 3.

FIG. 29 is a top view of the transport cart according to Embodiment 3.

FIG. 30 is an inverted perspective view of the transport member according to Embodiment 3.

FIG. 31 is a bottom view of the transport cart of Embodiment 3.

FIG. 32 is a perspective view of a cart according to Embodiment 3.

FIG. 33 is a front view of the cart according to Embodiment 3.

FIG. 34 is a side view of the cart according to Embodiment 3.

FIG. 35 is a top view of the cart according to Embodiment 3.

FIG. 36 is a perspective view of the cart in a folded state according to Embodiment 3.

FIG. 37 is a front view of the cart shown in FIG. 36.

FIG. 38 is a perspective view of the transport carts stacked up and down according to Embodiment 3.

FIG. 39 is a front view of the transport carts shown in FIG. 38.

FIG. 40 is a side view of the transport carts shown in FIG. 38.

FIG. 41 is a schematic diagram of an insertion member and an insertion matching member of a packaging container.

FIG. 42 is a schematic diagram of the insertion member and the insertion matching member, which are inserted into each other.

FIG. 43 is a perspective view of the packaging container according to Embodiment 1, showing a protruding platform.

### DETAILED DESCRIPTION OF THE EMBODIMENTS

The technical solutions in the embodiments of the present disclosure will be clearly and completely described below in conjunction with the drawings in the embodiments of the present disclosure. It is obvious that the described embodiments are only part of the embodiments of the present disclosure, rather than all the embodiments, and all other embodiments obtained by ordinary technicians in this field based on the embodiments of the present disclosure without making creative work are within the scope of protection of the present disclosure.

In the description of the present disclosure, it should be noted that the terms “upper”, “lower”, “inner”, “outer”, “top” “bottom”, and the like indicate positions or positional relationships based on the positions or positional relationships shown in the drawings, and are only for the convenience of describing the present disclosure and simplifying the description, rather than indicating or implying that the device or element referred to must have a specific position, be constructed and operated in a specific position, and therefore should not be understood as limiting the present disclosure. In addition, the terms “first” and “second” are used for descriptive purposes only and should not be understood as indicating or implying relative importance.

In the description of the present disclosure, it should be noted that, unless otherwise clearly stipulated and limited, the terms “installed”, “provided with”, “mounted”, “connected”, etc. should be understood in a broad sense. For example, “connection” can be a wall-mounted connection, a detachable connection, or an integral connection. It can be a mechanical connection or an electrical connection. It can be a direct connection or an indirect connection through an intermediate medium. It can be the internal connection of two components. For ordinary technicians in this field, the specific meanings of the above terms in the present disclosure can be understood according to specific circumstances.

### Embodiment 1

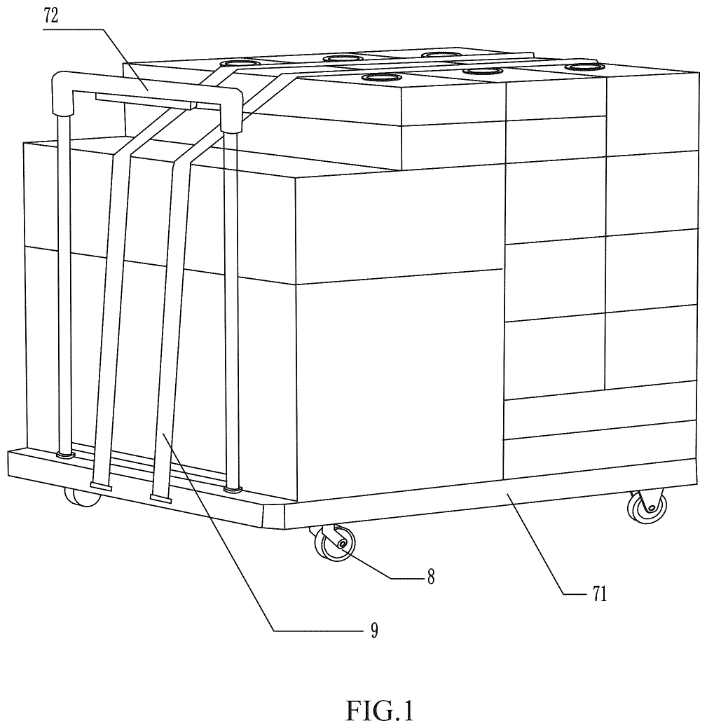

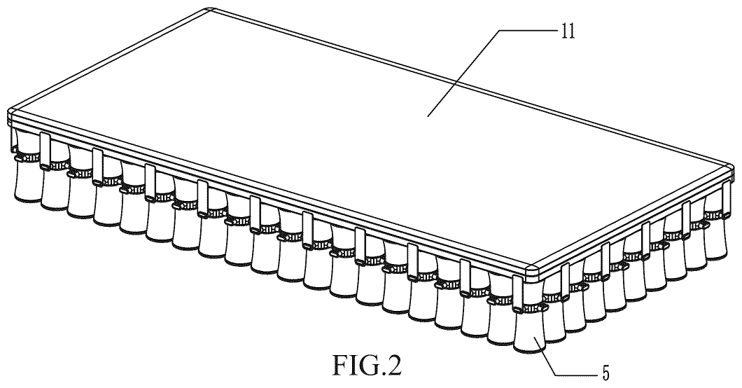

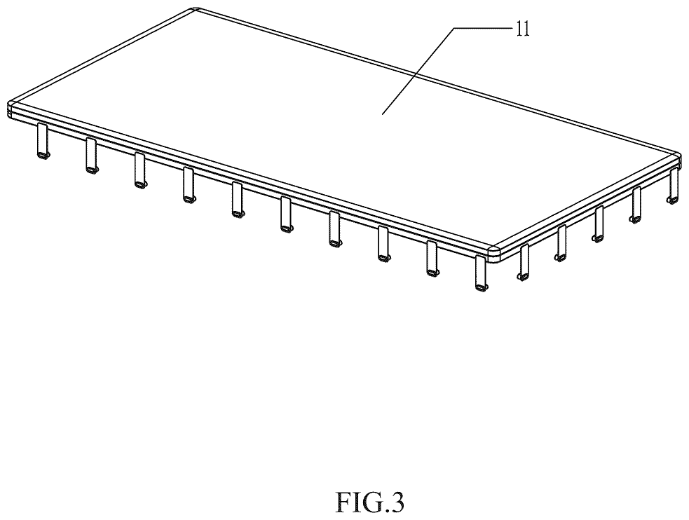

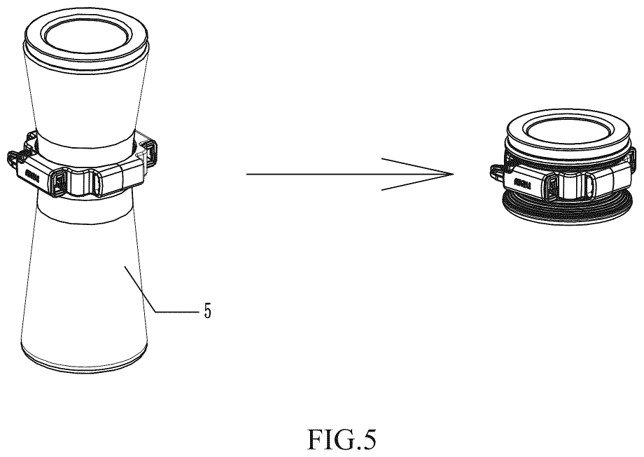

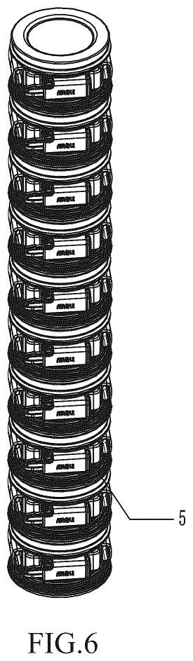

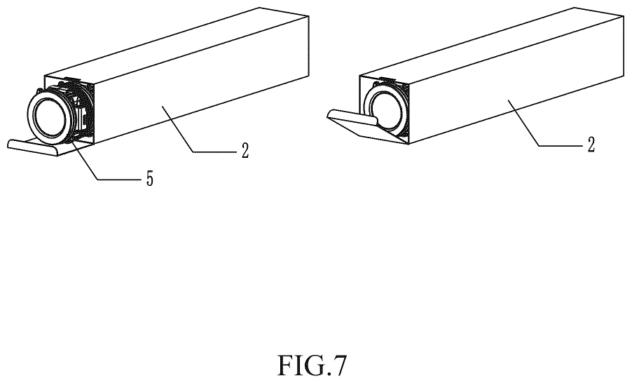

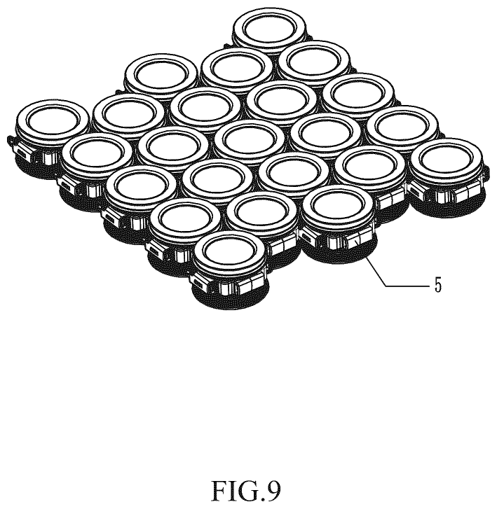

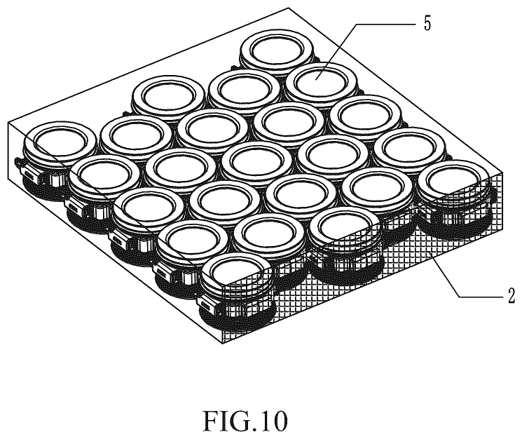

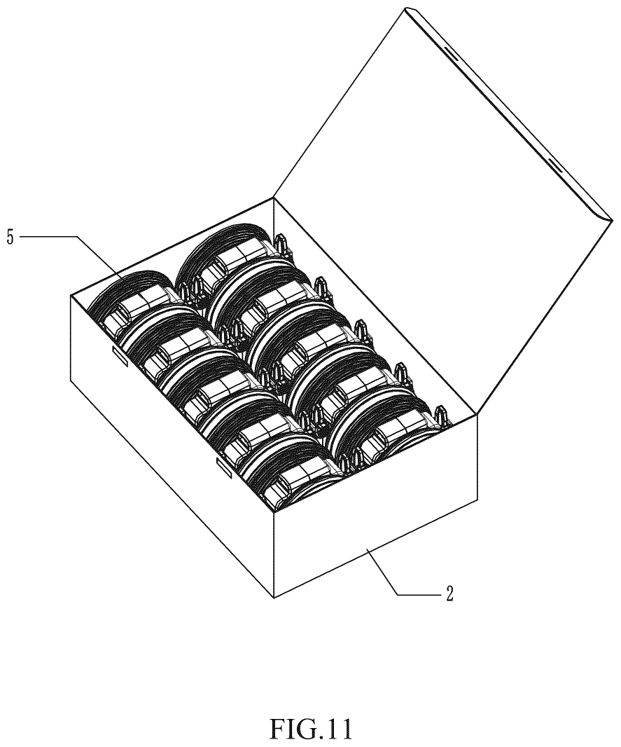

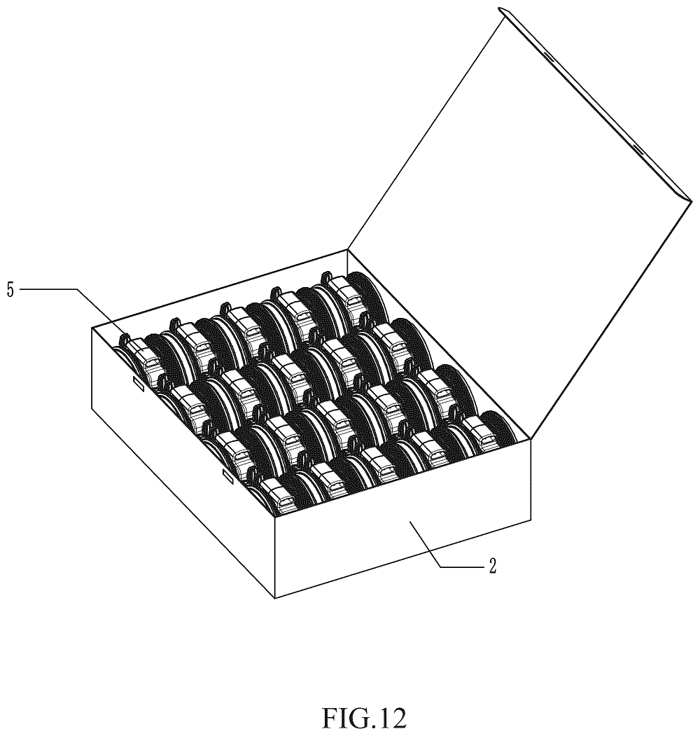

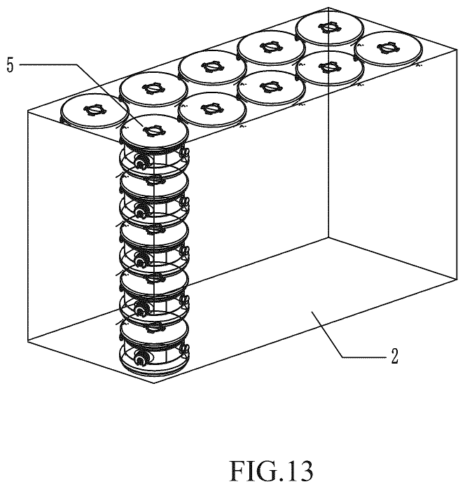

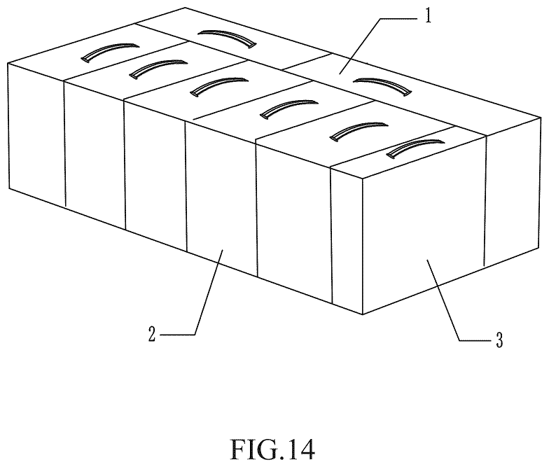

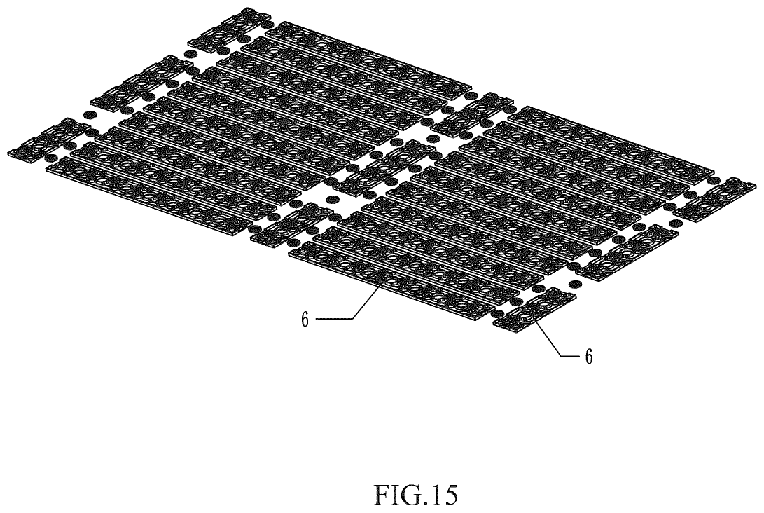

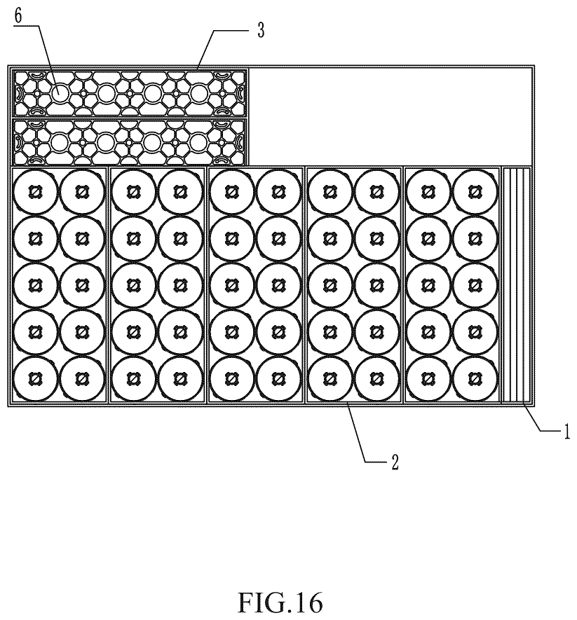

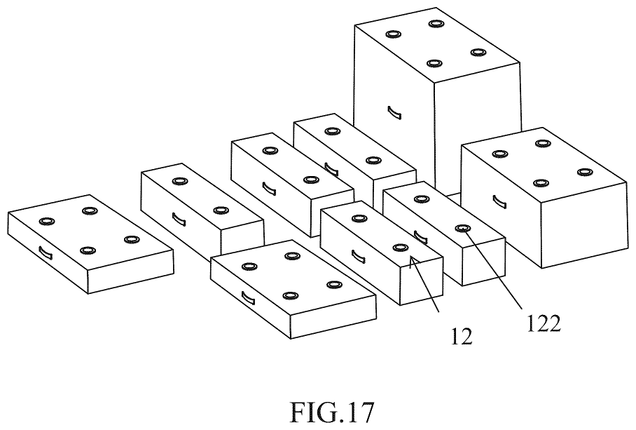

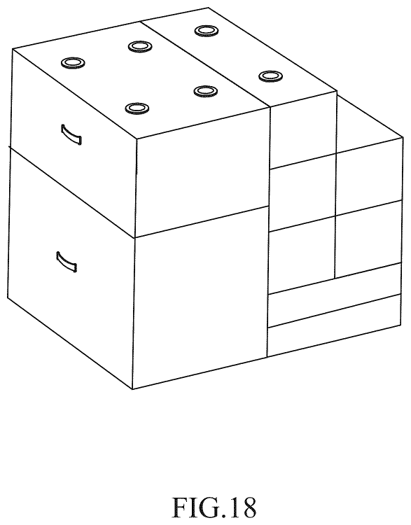

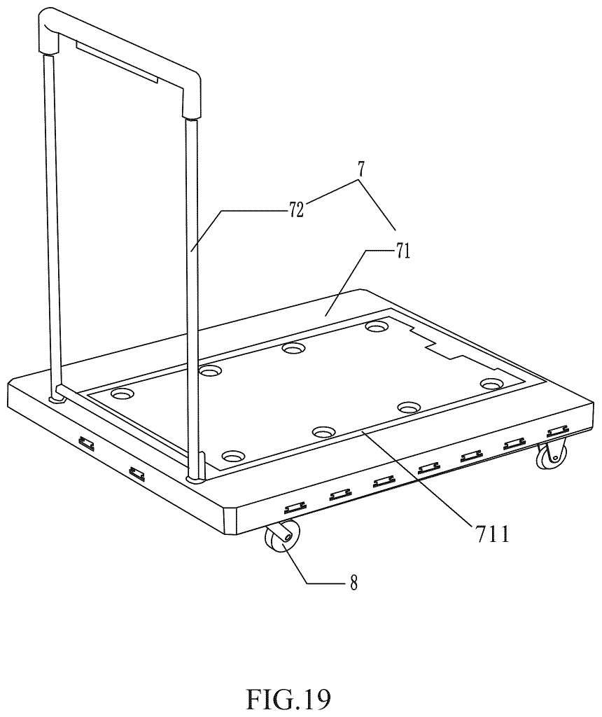

Referring to FIG. 1-19, this embodiment provides a packaging device and a transport cart, which are configured for packaging and transporting a detachable spring mattress. The detachable spring mattress comprises an upper cushion layer 11, an elastic module, and a bottom plate, which are detachable. The upper cushion layer 11 is a soft cushion layer. The elastic module is formed by detachably connecting a plurality of spring units 5. The bottom plate is formed by detachably splicing or unfolding a plurality of bottom plate units 6. Therefore, when merchants ship the detachable spring mattress or users transport the detachable spring mattress, the merchants or the users can separate the detachable spring mattress into the upper cushion layer 11, the plurality of spring units 5, and the plurality of bottom plate units 6 for packaging.

The packaging device of this embodiment comprises a plurality of packaging containers. Specifically, the plurality of packaging containers are divided into a first packaging container 1 for packaging the upper cushion layer 11, at least two second packaging containers 2 for packaging the plurality of spring units 5, and two or fewer third packaging containers 3 for packaging the plurality of bottom plate units 6.

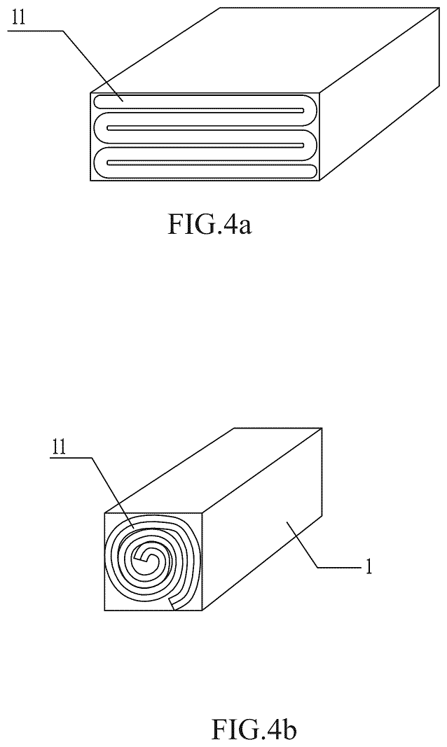

Since the upper cushion layer 11 is a soft cushion layer, the upper cushion layer 11 can be folded or rolled up to be put into the first packaging container 1. The first packaging container 1 can be an elongated packaging box, and the upper cushion layer 11 is rolled up and then put into the elongated packaging box, as shown in FIG. 4b. Alternatively, a flat packaging box as shown in FIG. 4a can be used, and the upper cushion layer 11 can be folded and then put into the flat packaging box. A shape and a size of the first packaging container 1 are specifically selected according to a volume and a size of the upper cushion layer 11, and there is no special limitation, as long as a purpose of the present disclosure can be achieved.

To load more of the plurality of spring units 5 into the at least two second packaging containers 2 to save on transportation size, in this embodiment, the plurality of spring units 5 can be locked in a compressed state. The plurality of spring units 5 locked in the compressed state are stacked in at least two second packaging containers 2.

When packaging the elastic module, all of the plurality of spring units 5 can be detached separately, and then the plurality of spring units 5 are compressed to the compressed state and stacked in the at least two second packaging containers 2. The plurality of spring units 5 can be stacked in the at least two second packaging containers 2 in a form of N₁×N₂×N₃, where N₁ is greater than or equal to 1, N₂ is greater than or equal to 1, and N₃ is greater than or equal to 1. Specifically, the plurality of spring units 5 can be stacked in an elongated packaging box in a 1*1*10 array, or the plurality of spring units 5 can be stacked in a flat packaging box in a 2*5*1 array or a 4*5*1 array, in other multi-row and multi-column arrays, or the plurality of spring units 5 can be stacked in a cubic packaging box in a 2*5*5 or other multi-row and multi-column and multi-group arrays.

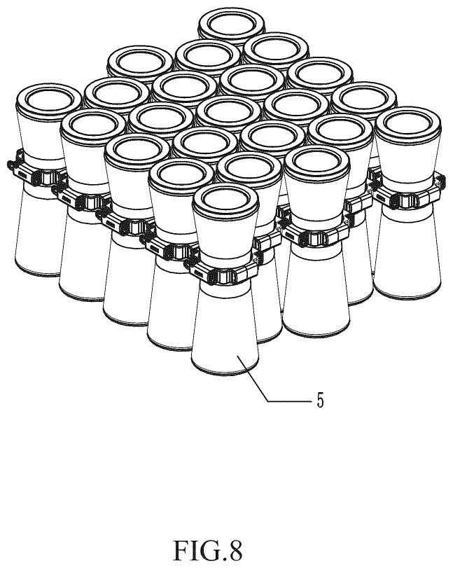

In addition, as shown in FIGS. 8-10, the elastic module can be disassembled to form modular units without separately disassembling the elastic module into the plurality of spring units 5, and then the modular units are stacked in the at least two second packaging containers 2 in a same stacking manner as described above. The bottom plate is disassembled to form the plurality of bottom plate units 6, and then the plurality of bottom plate units 6 are stacked and packaged in the two or fewer third packaging containers 3. As a simple alternative to this embodiment, the bottom plate can also be folded and packaged in the two or fewer third packaging containers 3 without the plurality of bottom plate units 6 being disconnected from each other.

The first packaging container 1, the at least two second packaging containers 2, and the two or fewer third packaging containers 3 that are filled with contents are stacked on each other to form the packaging device, and the packaging device is stacked on a cart 7.

Specifically, the cart 7 comprises a load-bearing portion 71, and the load-bearing portion 71 is a bottom supporting plate in a plate shape. Rollers 8 are installed below four corners of the bottom supporting plate, and a handle 72 perpendicular to the bottom supporting plate is disposed above the bottom supporting plate. The handle 72 is configured to be pushed to drive the cart 7. The cart 7 further comprises one or more straps 9 as a fixing member, and the one or more straps 9 are configured to tighten the plurality of packaging containers to fix the plurality of packaging containers on the cart 7.

When the merchant ships the detachable spring mattress or the user needs to transport the detachable spring mattress, components of the detachable spring mattress can be disassembled into smaller units, and then the smaller units are packaged in the first packaging container 1, the at least two second packaging containers 2, and the two or fewer third packaging containers 3 in the above manner. Then, the first packaging container 1, the at least two second packaging containers 2, and the two or fewer third packaging containers 3 are stacked on the cart 7 to be tightened with the one or more straps 9, so that the plurality of packaging containers are compactly and stably stacked on the cart 7. During transportation, pushing the handle 72 can drive the entire transport cart to move.

Compared with the traditional packaging and transportation methods, in this embodiment, during transportation, the plurality of packaging containers, which are smaller, can make the users save more effort during transportation, and then the spring mattress packaging device can be compactly and steadily held by the cart 7 during transportation. The cart 7 comprises the rollers 8 and handle 72 to make transportation more convenient and labor-saving.

When the cart 7 is idle, the cart 7 needs to occupy a certain storage space. In order to save the storage space occupied by the cart 7, the handle 72 has rotational freedom relative to the bottom supporting plate, and the handle 72 can be rotated to be parallel to the bottom supporting plate. In order to further save the storage space, a surface of the bottom supporting plate comprises a groove 711 having a shape matched with a shape of the handle 72 for receiving the handle 72.

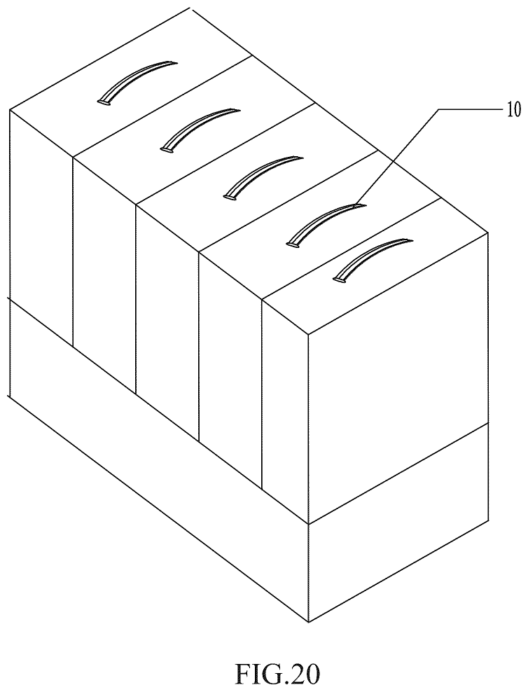

In order to make it easier for users to carry the first packaging container 1, the at least two second packaging containers 2, and the two or fewer third packaging containers 3, each of the plurality of packaging containers comprises a lifting handle 10 (see FIG. 20), and users can use the lifting handle 10 to lift the plurality of packaging containers, thereby saving effort.

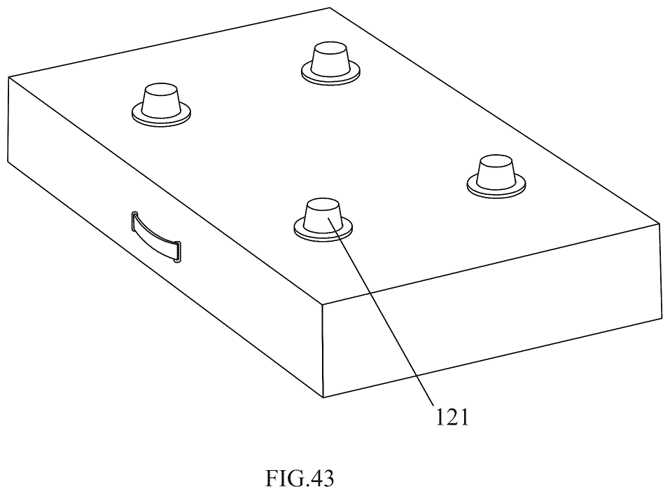

In order to make the first packaging container 1, the at least two second packaging containers 2, and the two or fewer third packaging containers 3 more compact and stable when stacked together, in the present embodiment, a surface of each of the plurality of packaging containers comprises a plurality of circular holes 12. Each of one or more first circular holes of the plurality of circular holes on a lower surface of each of the plurality of packaging containers is disposed with a protruding platform 121 (referring to FIG. 43) as an insertion member, and each of one or more second circular holes of the plurality of circular holes on an upper surface of each of the plurality of packaging containers is disposed with a recessed platform 122 as an insertion matching member. The recessed platform 122 is recessed vertically downward on the upper surface.

When the plurality of packaging containers are stacked in a vertical direction, the protruding platform 121 on the lower surface of each of plurality of packaging containers can be inserted into the recessed platform 122 on the upper surface of another one of plurality of packaging containers, so that adjacent packaging containers in the vertical direction are mutually interlocked with each other in a horizontal direction, reducing tipping of the plurality of packaging containers when the plurality of packaging containers are stacked to high.

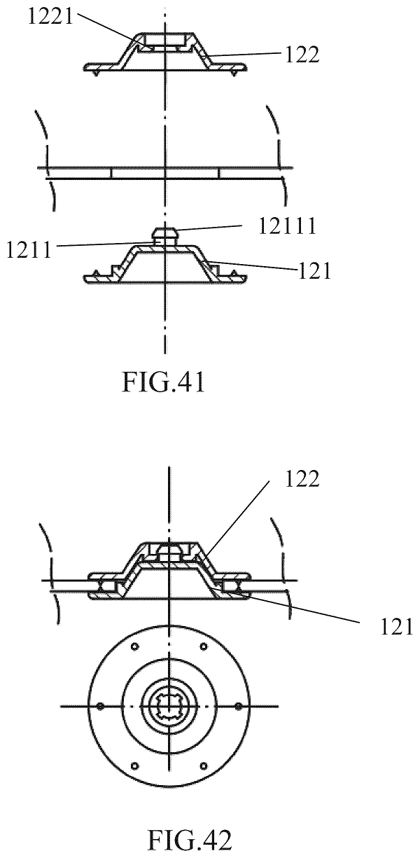

As a simple alternative to the present embodiment, as shown in FIGS. 41-42, a protruding platform 121 protruding in a vertical upward direction can be installed on the upper surface of each of the plurality of packaging containers as an insertion member, and a recessed platform 122 protruding in the vertical upward direction can be installed on the lower surface of each of the plurality of packaging containers as an insertion matching member. The protruding platform 121 comprises a protrusion 1211, an upper side of the protrusion 1211 comprises a protruding edge 12111 extending radially outward. A width of the protruding edge 12111 gradually narrows along an insertion direction to form an inclined surface. A surface of the recessed platform 122 comprises an opening 1221 for receiving the protrusion 1211. When stacking, the protrusion 1211 is inserted into the opening 1221 of the recessed platform 122, and the protruding edge 12111 and the surface of the recessed platform 122 are interlocked with each other to prevent the plurality of packaging containers from tipping over.

The upper surface and the lower surface of each of the plurality of packaging containers refer to an upper position and a lower position of each of the plurality of packaging containers when stacked. The upper surface and the lower surface of each of the plurality of packaging containers when not stacked are based on a placement orientation by the user. The lower surface when stacked may be the upper surface when not stacked.

In this embodiment, the insertion member or the insertion matching member may also be installed on the bottom supporting plate to further fix the plurality of packaging containers.

As a simple alternative to the present embodiment, the first packaging container 1, the at least two second packaging containers 2, and the two or fewer third packaging containers 3 can be freely combined and stacked on the cart 7. The first packaging container 1, the at least two second packaging containers 2, and the two or fewer third packaging containers 3 can be stacked on the cart 7 at the same time, and any two or one of the first packaging container 1, the at least two second packaging containers 2, or the two or fewer third packaging containers 3 can be selected to be stacked on the cart 7.

### Embodiment 2

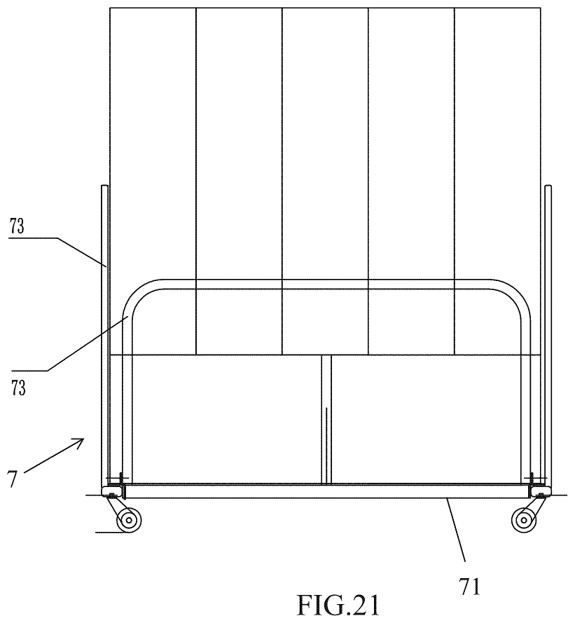

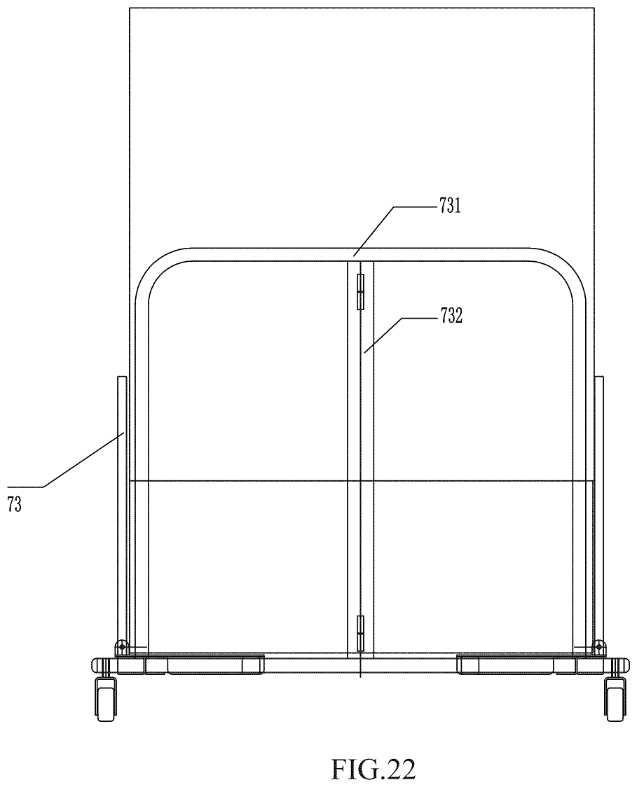

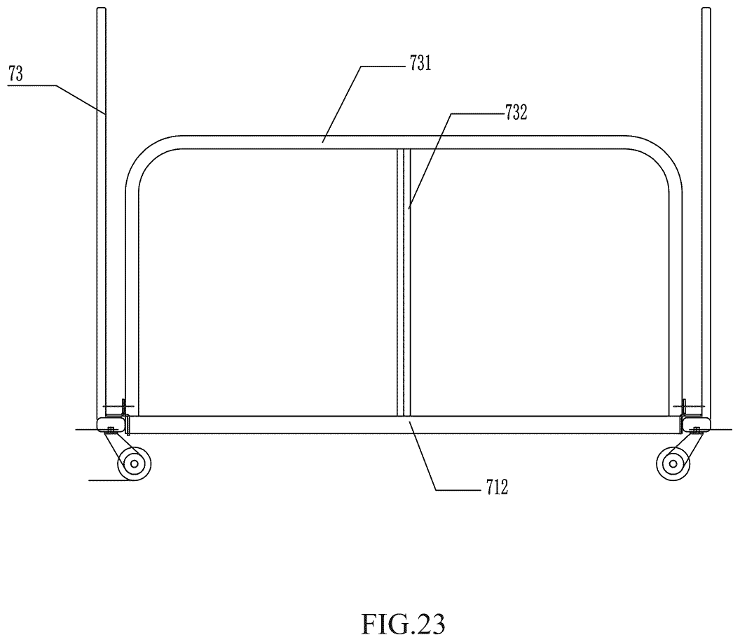

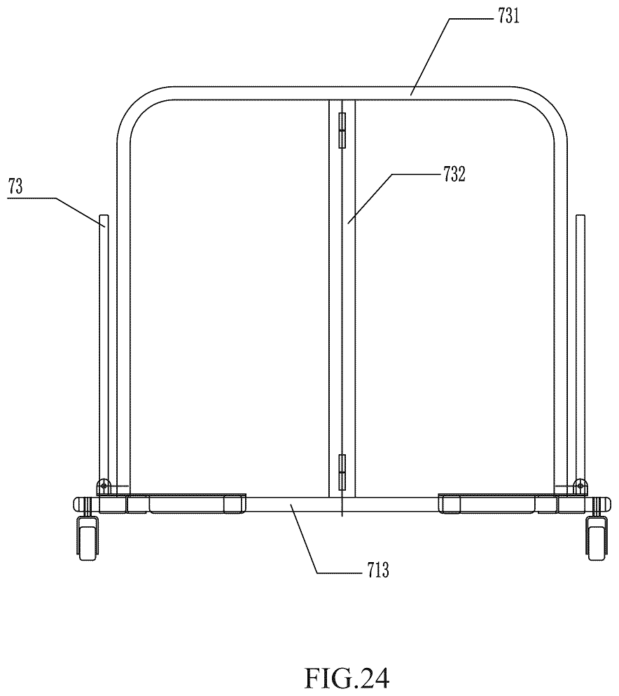

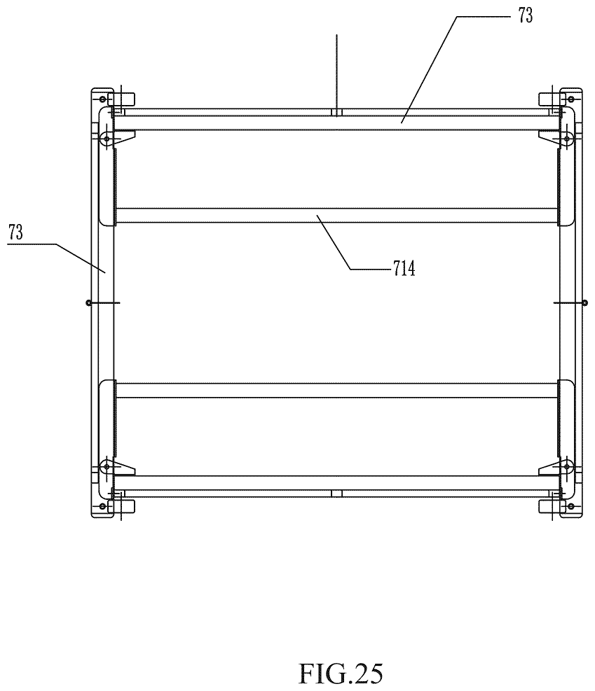

The fixing method using the one or more straps 9 may still cause the plurality of packaging containers to fall over during transportation. Therefore, in order to further fix the plurality of packaging containers on the cart 7, referring to FIGS. 20-25, in this embodiment, a guardrail 73 is provided around the load-bearing portion 71 as a fixing member to fix the plurality of packaging containers on the cart 7.

Specifically, the guardrail 73 comprises a first rail 731 parallel to the load-bearing portion 71 and a second rail 732 connected to the first rail 731 and the load-bearing portion 71. The first rail 731 and the second rail 732 cooperate with each other to fix the plurality of packaging containers on the load-bearing portion 71.

The difference between this embodiment and the first embodiment is that the load-bearing portion 71 of the cart 7 of this embodiment comprises two first transverse rods 712, two second transverse rods 713, and one or more connecting rods 714. The two first transverse rods 712 and the two second transverse rods 713 are connected to form a rectangular frame. The one or more connecting rods 714 are connected between the two first transverse rods 712 for carrying the plurality of packaging containers. The rest is the same as Embodiment 1 and will not be repeated here.

### Embodiment 3

The cart 7 in Embodiment 2 cannot be folded when not in use and occupies additional storage space.

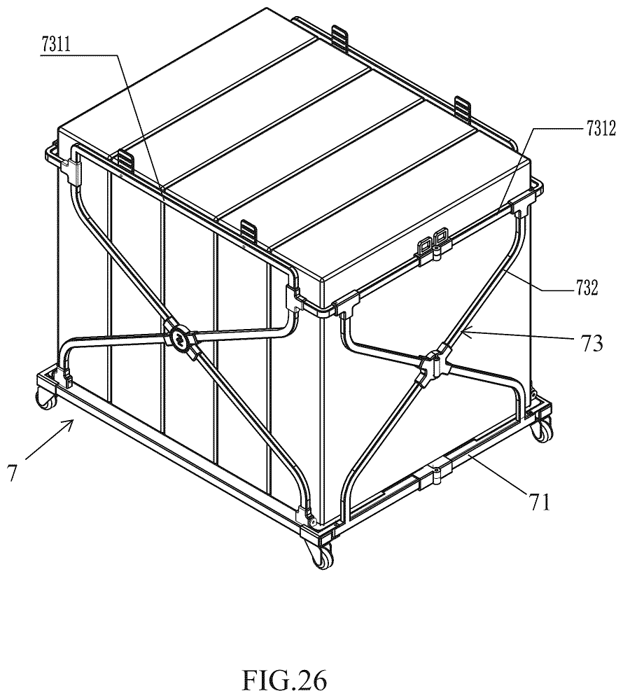

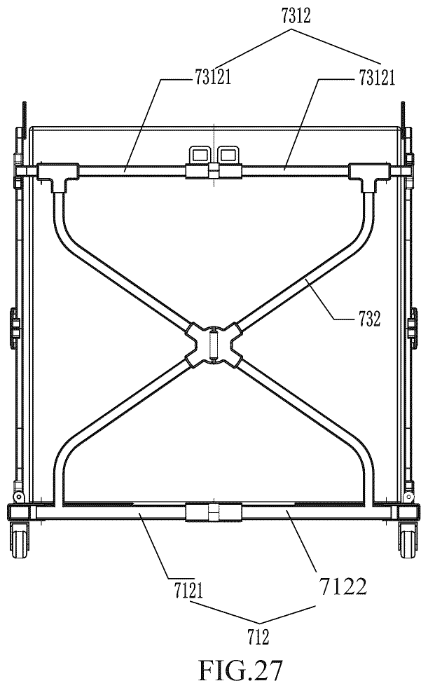

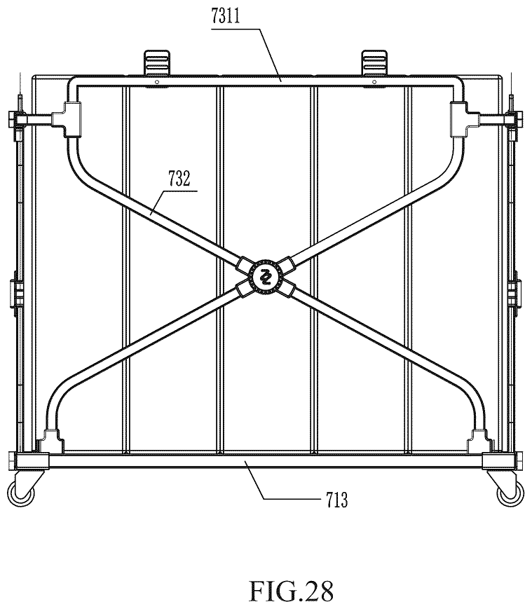

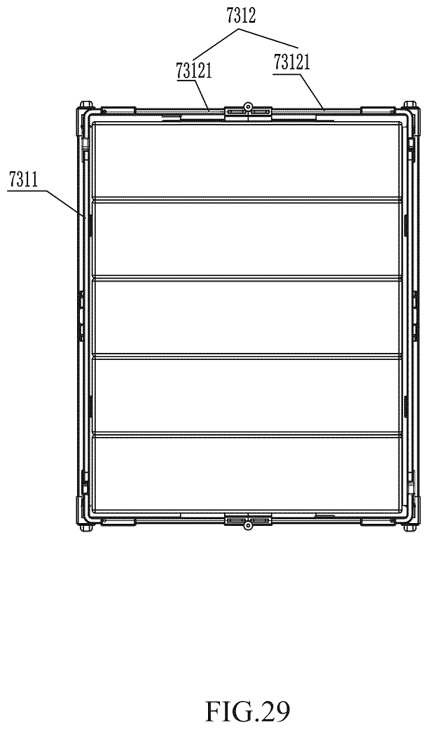

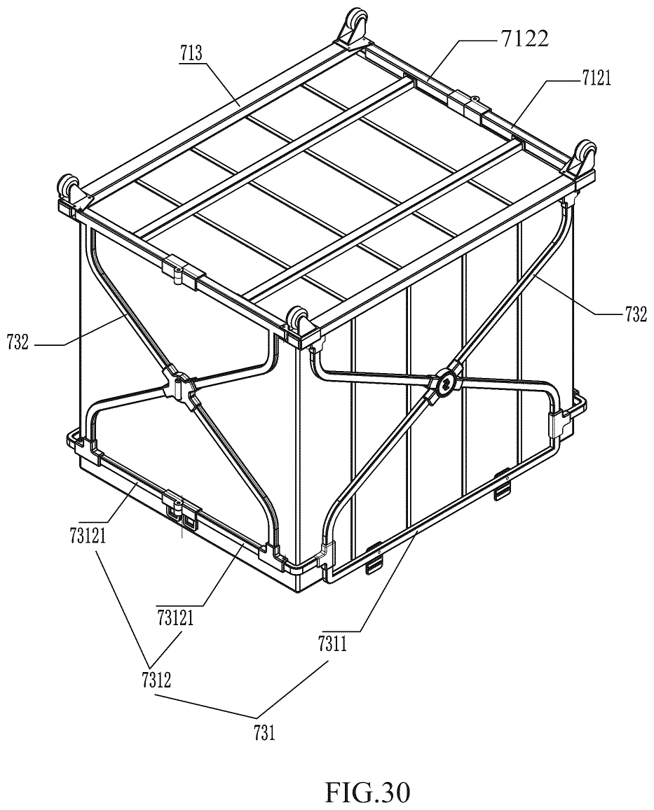

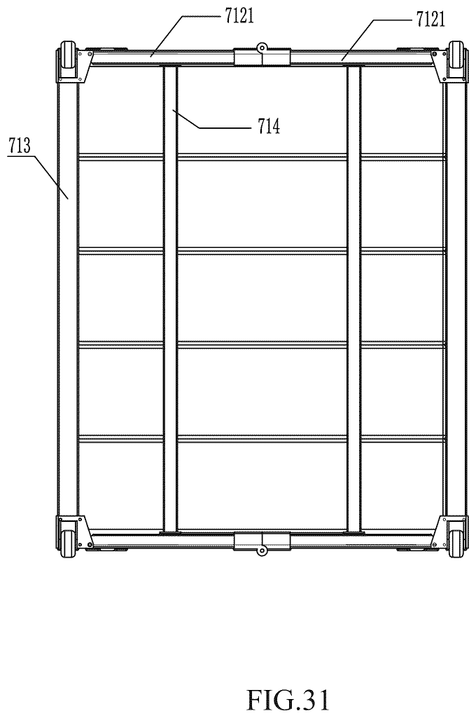

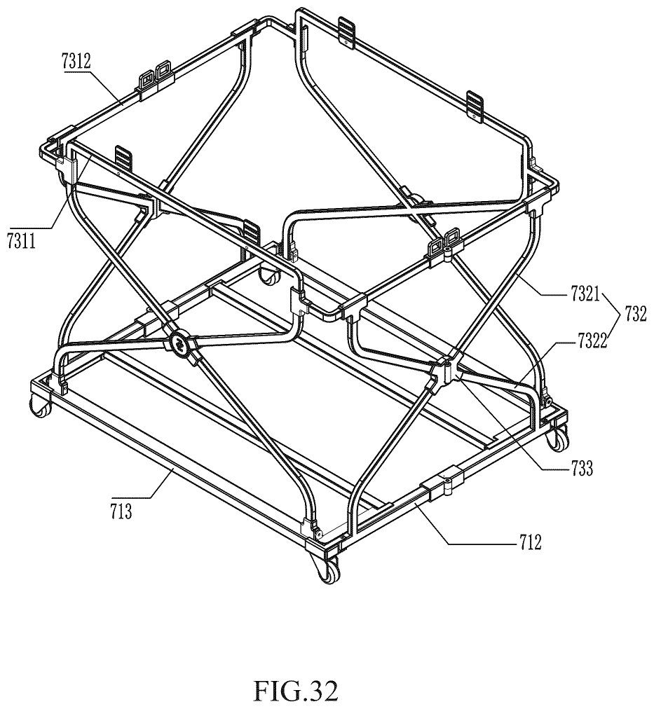

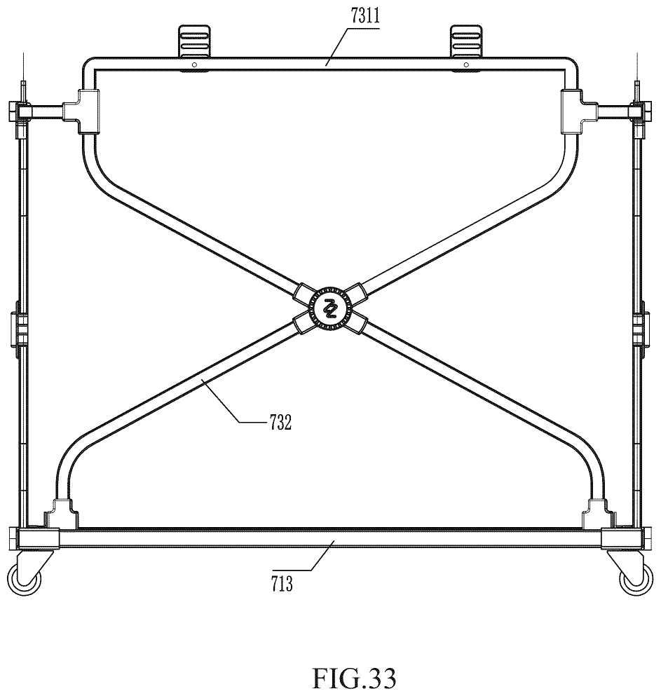

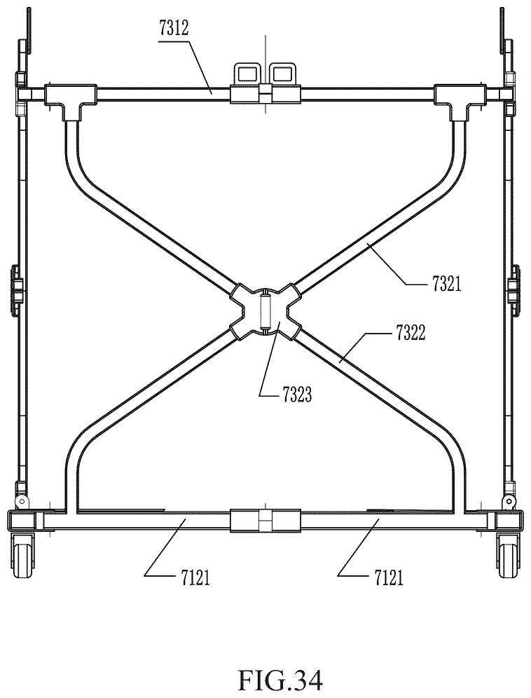

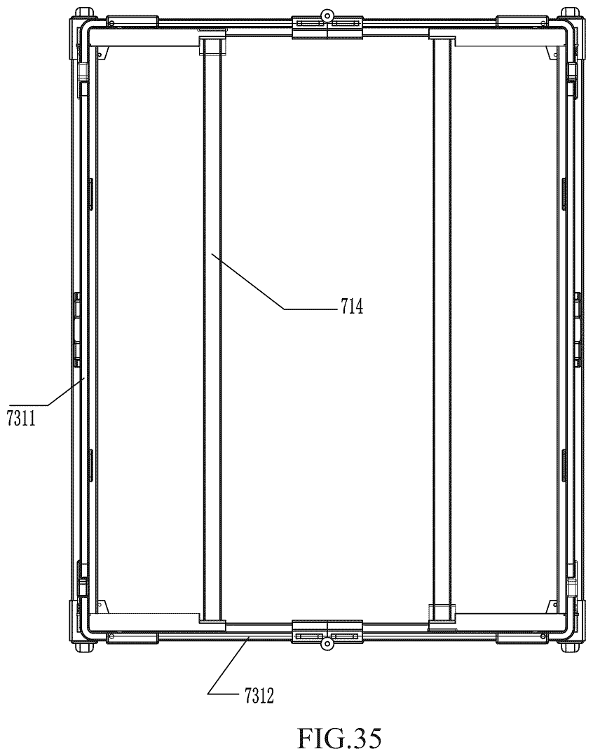

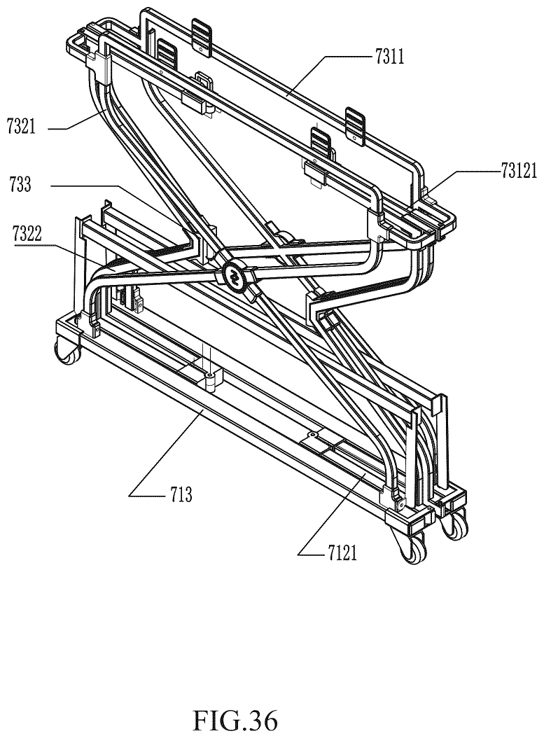

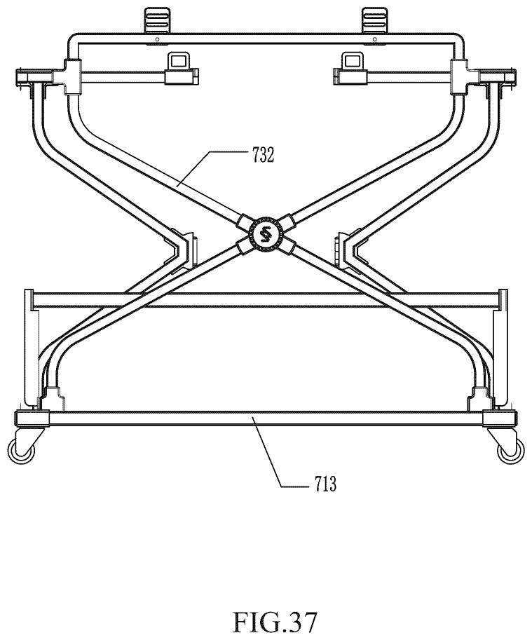

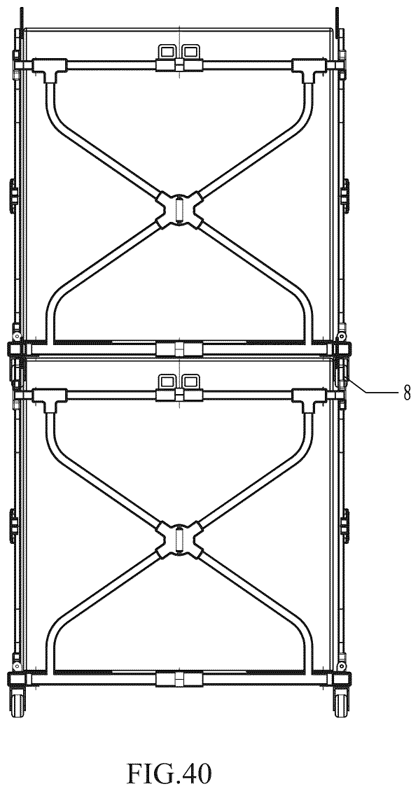

Referring to FIGS. 26-40, in order to make the cart 7 foldable when not in use, in the present embodiment, the load-bearing portion 71 of the cart 7 comprises two first transverse rods 712, two second transverse rods 713, and one or more connecting rods 714. The two first transverse rods 712 and the two second transverse rods 713 are connected to form a rectangular frame, and the one or more connecting rods 714 are connected between the two first transverse rods 712 for carrying the plurality of packaging containers. Each of the two first transverse rods 712 comprises a first part 7121 and a second part 7122, and the first part 7121 and the second part 7122 are respectively rotatably (specifically pivotally) connected to the two second transverse rods 713. The first part 7121 and the second part 7122 are also pivotally connected together to form a corresponding one of the two first transverse rods 712.

The first rail 731 of the guardrail 73 is divided into two fixed rods 7311 and two movable rods 7312. The two fixed rods 7311 are arranged opposite to each other, and the two movable rods 7312 are respectively rotatably connected between ends of the two fixed rods 7311. Each of the two movable rods 7312 is divided into two sub-movable rods 73121, and ends of the two sub-movable rods 73121 facing away from each other are respectively rotatably connected to the ends of the two fixed rods 7311. Ends of the two sub-movable rods 73121 facing each other are rotatably connected.

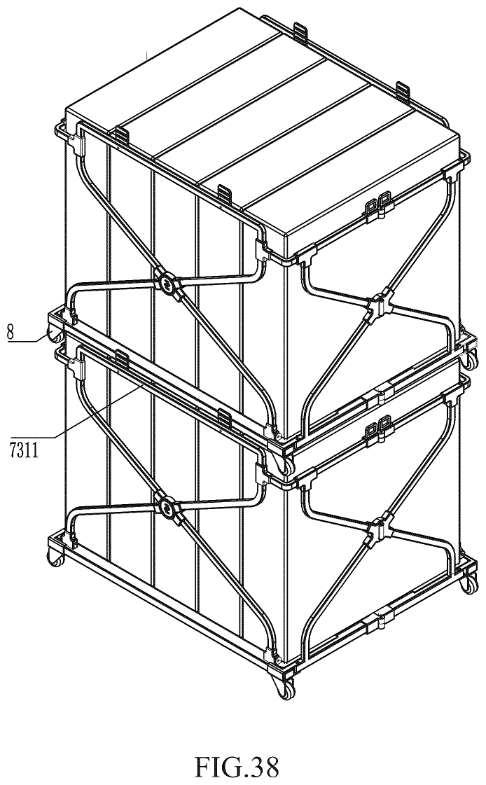

As shown in FIG. 38, an external force is applied to a surface on the two second transverse rods 713 of the cart 7, and the first part 7121 and the second part 7122 of each of the two first transverse rods 712 are rotated to be parallel to the two second transverse rods 713 and overlap each other. At the same time, the two movable rods 7312 of the guardrail 73 are rotated to be parallel to the two fixed rods 7311 and overlap each other, thereby folding the cart 7. The cart 7, which folded, does not occupy as much storage space.

In order to prevent the plurality of packaging containers from tipping out of the guardrail 73, in the present embodiment, the guardrail 73 comprises a plurality of second rails 732, and two ends of each of the plurality of second rails 732 of the guardrail 73 are respectively connected to the first rail 731. Middle sections of adjacent second rails 732 of the plurality of second rails 732 on a same side of the load-bearing portion 71 extend toward each other and are connected together to form an X-shaped guardrail, thereby preventing the plurality of packaging containers from slipping out from the side of the guardrail 73 and further stabilizing the plurality of packaging containers.

At the same time, in order to prevent the X-shaped guardrail from affecting folding of the cart 7, the plurality of second rails 732 of the guardrail 73 on two sides of guardrail 73 where the two first transverse rods 712 are located each comprises an upper rail 7321, a lower rail 7322, and a connecting member 733. A first end of the upper rail 7321 is connected to the first railing 731, and a first end of the lower rail 7322 is connected to the load-bearing portion 71. A second end of the upper rail 7321 and a second end of the lower rail 7322 are connected to the connecting member 733. The connecting members 733 of two adjacent second rails 732 of the plurality of second rails 732 are pivotally connected. Therefore, the two adjacent second rails 732 pivotally connected to each other can also be rotated parallel to the two second transverse rods 713 due to the external force, and the two adjacent second rails 732 overlap each other to be folded.

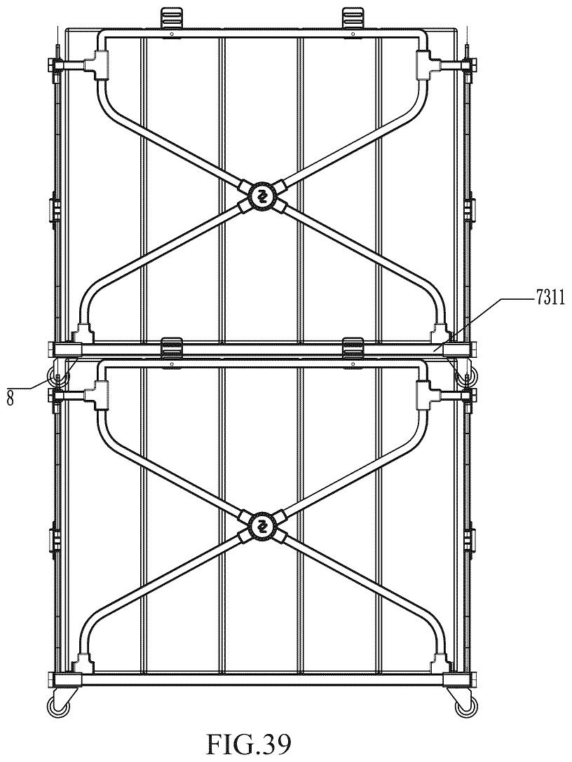

In order to enable the carts 7 to be stacked vertically without affecting the plurality of packaging containers, as shown in FIG. 38-39, in this embodiment, two ends of each of the two fixed rods 7311 extend vertically downward to form a space for the rollers 8 to be inserted, and two ends of the two movable rods 7312 are respectively connected to the two ends of a corresponding one of the two fixed rods 7311 which extend downward. Thus, when two of the carts 7 are stacked vertically, the rollers 8 of an upper cart 7 just insert into the space formed by the two fixed rods 7311 of a lower cart 7, and the rollers 8 do not interfere with the lower cart 7, thereby preventing the product from being crushed.

The above is only a preferred, specific implementation of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure

What is claimed is:

1. A packaging method for a spring mattress, wherein:
the spring mattress comprises an upper cushion layer, an elastic module, and a bottom plate,
the elastic module is formed by detachably connecting a plurality of spring units,
the bottom plate is formed by detachably splicing or unfolding a plurality of bottom plate units, and
the packaging method comprises packaging the plurality of spring units using at least two of a plurality of packaging containers, packaging the upper cushion layer using a single one of the plurality of packaging containers, and packaging the plurality of bottom plate units using two or fewer of the plurality of packaging containers.

2. The packaging method for the spring mattress according to claim 1, wherein:
the plurality of spring units are configured to be locked in a compressed state, and
the plurality of spring units locked in the compressed state are stacked in the at least two of the plurality of packaging containers.

3. A packaging device for a spring mattress, wherein:
the spring mattress comprises an upper cushion layer, an elastic module, and a bottom plate,
the elastic module is formed by detachably connecting a plurality of spring units,
the bottom plate is formed by detachably splicing or unfolding a plurality of bottom plate units,
the plurality of spring units are configured to be packaged using at least two of a plurality of packaging containers,
the upper cushion layer is configured to be packaged using a single one of the plurality of packaging containers, and
the plurality of bottom plate units are configured to be packaged using two or fewer of the plurality of packaging containers.

4. The packaging device for the spring mattress according to claim 3, wherein:
the upper cushion layer is rolled up or folded to be put into the single one of the plurality of packaging containers.

5. The packaging device for the spring mattress according to claim 3, wherein:
the bottom plate is configured to be stacked in the two or fewer of the plurality of packaging containers after being disassembled from the plurality of spring units.

6. The packaging device for the spring mattress according to claim 3, wherein:
a surface of one of the plurality of packaging containers is disposed with an insertion member,
a surface of another one of the plurality of packaging containers opposite to the surface of the one of the plurality of packaging containers is disposed with an insertion matching member, and
when the plurality of packaging containers are stacked along a vertical direction, the insertion member and the insertion matching member are matched with each other by insertion.

7. The packaging device for the spring mattress according to claim 6, wherein:
a surface of each of the plurality of packaging containers comprises a circular hole,
the circular hole on a lower surface of the one of the plurality of packaging containers is mounted with a protruding platform as the insertion member, and
the circular hole on an upper surface of the another one of the plurality of packaging containers is mounted with a recessed platform as the insertion matching member.

8. The packaging device for the spring mattress according to claim 6, wherein:
a surface of each of the plurality of packaging containers comprises a circular hole,
the circular hole on an upper surface of the one of the plurality of packaging containers is mounted with a protrusion protruding in a vertical upward direction as the insertion member, and
the circular hole on a lower surface of the another one of the plurality of packaging containers is mounted with a recessed platform recessed in the vertical upward direction as the insertion matching member.

9. The packaging device for the spring mattress according to claim 8, wherein:
an upper side of the protrusion comprises a protruding edge extending radially outward,
a width of the protruding edge gradually narrows along an insertion direction to form an inclined surface, and
the recess platform comprises an opening into which the protruding edge is inserted.

10. A transport cart for a detachable spring mattress, wherein:
the transport cart is configured to transport the detachable spring mattress,
the transport carts and the detachable spring mattress are in a one-to-one correspondence,
the transport cart comprises a cart,
the packaging device according to claim 3 is stacked on the cart,
the cart comprises a fixing member, and
the fixing member is configured to fixing the packaging device on the cart.

11. The transport cart for the detachable spring mattress according to claim 10, wherein:
the cart comprises a load-bearing portion configured to support the packaging device, and
rollers are disposed below the load-bearing portion.

12. The transport cart for the detachable spring mattress according to claim 11, wherein:
the fixing member is one or more straps, and
the one or more straps are configured to tighten the packaging device to fix the packaging device on the cart.

13. The transport cart for the detachable spring mattress according to claim 11, wherein:
a handle is disposed above the load-bearing portion,
the handle is configured to be pushed to drive the cart,
the handle has rotational freedom relative to the load-bearing portion,
the handle is configured to be rotated to be parallel to the load-bearing portion,
the load-bearing portion is a bottom supporting plate in a plate shape, and
a surface of the bottom supporting plate comprises a groove having a shape matched with a shape of the handle for receiving the handle when the handle is rotated to be parallel to the load-bearing portion.

14. The transport cart for the detachable spring mattress according to claim 11, wherein:
the fixing member is a guardrail provided around the load-bearing portion to fix the packaging device on the cart.

15. The transport cart for the detachable spring mattress according to claim 14, wherein:
the guardrail comprises a first rail parallel to the load-bearing portion and one or more second rails connected to the first rail and the load-bearing portion.

16. The transport cart for the detachable spring mattress according to claim 15, wherein:
the first rail is divided into two fixed rods and two movable rods,
the two fixed rods are arranged opposite to each other,
the two movable rods are respectively rotatably connected between ends of the two fixed rods,
each of the two movable rods is divided into two sub-movable rods,
ends of the two sub-movable rods facing away from each other are respectively rotatably connected to the ends of the two fixed rods, and
ends of the two sub-movable rods facing each other are rotatably connected.

17. The transport cart for the detachable spring mattress according to claim 15, wherein:
the one or more second rails are a plurality of second rails,
two ends of each of the plurality of second rails are respectively connected to the first rail and the load-bearing portion, and
middle sections of adjacent second rails of the plurality of second rails on a same side of the load-bearing portion extend toward each other and are connected together.

18. The transport cart for the detachable spring mattress according to claim 17, wherein:
each of the plurality of second rails comprises an upper rail, a lower rail, and a connecting member,
a first end of the upper rail is connected to the first rail,
a first end of the lower rail is connected to the load-bearing portion,
a second end of the upper rail and a second end of the lower rail are connected to the connecting member,
the connecting members of two adjacent second rails of the plurality of second rails are pivotally connected,
the load-bearing portion comprises two first transverse rods, two second transverse rods, and one or more connecting rods,
the two first transverse rods and the two second transverse rods are connected to form a rectangular frame, and
the one or more connecting rods are connected between the two first transverse rods for carrying the packaging device.

19. The transport cart for the detachable spring mattress according to claim 18, wherein:
each of the two first transverse rods comprises a first part and a second part,
the first part and the second part are respectively rotatably connected to the two second transverse rods, and
the first part and the second part are pivotally connected together to form a corresponding one of the two first transverse rods.

20. The transport cart for the detachable spring mattress according to claim 16, wherein:
two ends of each of the two fixed rods extend vertically downward to form a space for the rollers to be inserted, and
two ends of the two movable rods are respectively connected to the two ends of a corresponding one of the two fixed rods which extend downward.
